(19) United States
(12) Patent Application Publication
(10) Pub. No.: US 2011/0217410 A1
(43) Pub. Date: Sep. 8, 2011

(54) STABILIZED VITAMIN C IN FOODS AND BEVERAGES

(76) Inventor: Daniel Perlman, Arlington, MA (US)

(21) Appl. No.: 12/703,825

(22) Filed: Feb. 11, 2010

(51) Int. Cl. A23L 1/302; A23L 2/52; B65D 81/30

(52) U.S. Cl. 426/2; 426/72; 426/442

(57) ABSTRACT

A vitamin C-fortified processed aqueous food or beverage composition for human or animal consumption and methods for preparing such compositions are described. The composition includes at least one water-solubilized chemical source of vitamin C and at least one water-insoluble microparticulate chemical source of ascorbate. The water-soluble vitamin C and the water-insoluble source of ascorbate are both dispersed in the composition that is free of an amount of available solvent that would dissolve the water-insoluble source of ascorbate. The microparticulate ascorbate acts to reduce the rate of loss of vitamin C in the composition.

### RELATED APPLICATIONS

NOT APPLICABLE.

### FIELD OF THE INVENTION

The present invention relates to compositions and methods for stabilizing vitamin C in aqueous foods and beverages.

### BACKGROUND OF THE INVENTION

The following discussion is provided solely to assist the understanding of the reader, and does not constitute an admission that any of the information discussed or references cited constitute prior art to the present invention.

Vitamin C is a water-soluble vitamin that must be provided in the human diet because it is not synthesized by the body. It is physiologically required for synthesis of many essential tissues as well as biomolecules including neurotransmitters, fat transport molecules and for catabolism of a portion of the body's cholesterol. Vitamin C is also an effective antioxidant in vivo for protecting many proteins, fats, carbohydrates and nucleic acids from damaging reactive oxygen and free radical species. A review article on vitamin C from the Linus Pauling Institute is found at the URL address: http://lpi.oreqonstate.edu/infocenter/vitamins/vitaminC/. The following information is extracted from that review. A well characterized disease that is prevented by regular ingestion of as little as 10 mg of vitamin C daily is scurvy, a multi-faceted disease of vitamin C deficiency. Data from a number of large scale prospective and retrospective clinical and epidemiological studies suggests that ingesting enough vitamin C to essentially saturate the plasma (about 400 mg/day) over a period of years can lower the risk of coronary heart disease (CHD) approximately 25%. Similarly, the risk of stroke may be reduced as much as 29% in people with the highest serum levels of the vitamin. The risk of contracting a variety of cancers including GI tract, lung and possibly breast cancer appears to be reduced by vitamin C supplements. Vitamin C supplementation at levels of 500 mg per day has been shown to beneficially enhance vasodilation in patients with a variety of circulatory diseases.

While a maximum safe level of vitamin C has not been established, it is known that daily intake of 0.5 to 1 gram for children and up to 2 grams per day for adolescents and adults is safe and effective. While such levels may be desirable goals for some health-conscious individuals, it is currently believed that the adult population will benefit most by consuming approximately 400 mg per day of vitamin C, preferably from a combination of fruit and vegetables, to which may be added dietary supplements.

Oxidative and/or hydrolytic breakdown of unstable nutrients contained in processed food products is a significant problem faced by formulators of processed foods throughout the world. Some nutrients and micronutrients that lack oxidative and/or hydrolytic stability exist as endogenous substances in processed foods, while others such as vitamins A, D and E are often exogenously added to improve the nutritional profile of the food.

A variety of strategies have been employed to stabilize both endogenous and exogenously added perishable but beneficial nutrients, such as the highly unsaturated and rancidity-prone omega-3 fatty acids and vitamin C in processed foods. For example, microencapsulation has been used to package such nutrients and micronutrients, so as to separate them from the surrounding medium that would otherwise destabilize, oxidize, or otherwise degrade these substances. On the other hand, Perlman in U.S. Pat. No. 7,344,747 utilizes a very different strategy to stabilize omega-3 fatty acids found in flaxseed oil or fish oil, by diluting the oil into an oleic acid-rich edible oil such as high oleic sunflower oil or the oil present in peanut butter produced from a high oleic variety of peanuts.

Alternatively, sacrificial antioxidant agents including natural alpha-tocopherol (vitamin E), or synthetic TBHQ, BHA, BHT, propyl gallate and ascorbyl palmitate may be added to foods to protect nutrients that are susceptible to oxidation. While these particular agents are fat-soluble and are useful for protecting polyunsaturated fatty acids and natural colors and flavors against oxidation, there are also sacrificial antioxidants that are water-soluble and useful for protecting perishable nutrients in the aqueous portion of processed foods. Examples of the latter include vitamin C and salts thereof, L-cysteine, and TBHQ (having solubility in fat as well).

Interestingly, if multiple antioxidants are present in the fat or the water portion of a processed food, the most readily oxidized antioxidant tends to be sacrificed first, protecting the other antioxidants from degradation. For example, when water-soluble vitamin C is added to grape juice as a sacrificial antioxidant, it can protect bio-functional proanthocyanidin phenolic antioxidants in the juice. Similarly, the synthetic fat-soluble antioxidants, ascorbyl palmitate and TBHQ, function as sacrificial antioxidants in a vegetable oil to protect omega-3 fatty acids and carotenoid antioxidants such as lutein or lycopene if they are also present.

In food applications, vitamin C is somewhat unique because it may be used in foods and beverages either as a food additive and sacrificial antioxidant to protect perishable ingredients, or as a supplemental vitamin micronutrient. However, due to its susceptibility to oxidative decomposition, the utility and practicality of adding vitamin C as a micronutrient to foods and beverages has been questioned. For example, Gliguem et al. (J. Dairy Sci. 88: 891-899, 2005) describe processing and storage factors affecting the stability of vitamin C and its levels persisting in milk. These include the sterilization process, extent of oxygen and light penetration of the packaging, and the duration of storage.

With regard to photodegradation of vitamin C, over 70 years ago Kon, et al. (Biochem. Jour., 30: 2273-2290, 1936) carried out and published a series of elegant experiments on the effect of light on the vitamin C content of milk. Among other discoveries, these investigators found that photo-oxidizing light penetrated through more than 1 cm of milk to degrade vitamin C. Furthermore, after some or all of the milk's ascorbic acid had been photo-oxidized to dehydroascorbic acid (a reversibly oxidized, but biologically active form of vitamin C), this dehydroascorbic acid continued to be oxidized, even in the dark, to an irreversibly degraded and biologically inactive product. Using colored cellophane coverings over test tubes filled with milk, Kon, et al. then showed that while green, blue and violet light diminished both ascorbate and dehydroascorbate levels in milk, red light exposure resulted in negligible loss of either form of vitamin C.

Ascorbyl palmitate (abbreviated “AP” herein) is a fat-soluble antioxidant that consists of ascorbic acid and an ester-linked 16 carbon fatty acid, palmitic acid. AP has been used to increase the shelf life of fatty foods and fat-containing cosmetics. Being amphipathic, AP has been frequently used in topical preparations such as skin creams that combine fat-soluble ingredients and water. The question of whether AP dissolved in a fat as a sacrificial antioxidant is more stable or less stable than simple water-soluble forms of vitamin C has been debated, and may depend upon the chemical environment in which AP and vitamin C are found.

Because of the utility of AP as an amphipathic antioxidant in products containing both lipophilic and hydrophilic ingredients, the stability of AP has been the subject of study in such mixed systems such as microemulsions. For example, Spiclin et al. (IntI. J. Pharmaceutics, 222: 271-279, 2001) describe conditions that either increase or decrease the stability of AP in such microemulsions. These investigators found that reduced levels of molecular oxygen (by degassing) and high concentrations of AP reduced the extent of degradation of AP. Furthermore, for oil-solubilized AP, water-in-oil emulsions stabilized AP to a greater degree than oil-in-water. The latter observation can be explained by the reduced solubility of oxygen in water compared to oil, and the reduced exposure of the ascorbyl moiety extending into water microdroplets in a water-in-oil microemulsion compared to a greater exposure when water is the external phase in a microemulsion. Daylight exposure was also found to accelerate the degradation of AP, much like vitamin C.

According to current U.S. FDA regulations governing food additives and processed foods, ascorbic acid (C.A.S. #50-81-7) and its salts such as calcium ascorbate, dihydrate (C.A.S. 5743-28-2), sodium ascorbate (C.A.S. 134-03-2), potassium ascorbate (C.A.S. 15421-15-5) and other salts (collectively termed “vitamin C” herein) are GRAS (generally recognized as safe) substances for addition to foods and beverages when used in accordance with good manufacturing practices.

Some or even all of vitamin C added to foods and beverages is routinely and reversibly oxidized to dehydroascorbic acid (C.A.S. 490-83-5) either in situ within foods, or in vivo following ingestion. Given the fact that dehydroascorbic acid possesses vitamin C biological activity and can be reversibly converted back to vitamin C, this molecular species is also considered “vitamin C” for the purposes of this invention. Dehydroascorbic acid has multiple functions in vivo, being the form of vitamin C imported into the cellular endoplasmic reticulum and serves as an enzymatic cofactor and intracellular antioxidant. Unlike ascorbic acid, it crosses the blood-brain barrier to be subsequently reduced back to ascorbic acid within the brain.

Returning again to the topic of AP, i.e., the fat-soluble palmitic acid-ester derivative of ascorbic acid (ascorbyl palmitate, C.A.S. #137-66-6), this substance, like ascorbic acid, is GRAS for use in foods. Ascorbyl stearate (C.A.S. #10605-09-1) is a homologous ester and source of vitamin C, but at present its use is limited by the FDA to that of an antioxidant food additive in margarine with a maximum usage level of 0.02%. As sacrificial antioxidants added to foods and beverages, both vitamin C dissolved in aqueous foods and beverages, and AP dissolved in fats, are susceptible to oxidation. Equivalent levels of AP or ascorbyl stearate dissolved in a fatty food may in fact, be more susceptible to oxidative degradation than vitamin C, e.g., calcium ascorbate, dissolved in an aqueous beverage owing to the greater solubility of oxygen in fat compared to water. In fact, the molecular oxygen component in air at room temperature and one atmosphere pressure is approximately five times more soluble in vegetable oils, e.g., soybean oil, than in water.

As sacrificial antioxidants, and because of their solubility differences, vitamin C, AP, and ascorbyl stearate are all useful in protecting oxidation-susceptible, perishable food ingredients. In spite of AP being several-fold more costly than vitamin C, because AP is fat-soluble and also GRAS approved, it is particularly useful for protecting deep-frying oils and ingredients carried within fats (e.g., fish oil omega-3 fatty acids, flavorings and colors) from premature oxidation. More specifically, AP functions as a scavenger of reactive oxygen and free radicals in fats and vegetable oils thereby extending the shelf life of many processed food products. AP can also be used in combination and synergistically with other fat-soluble antioxidants such as alpha-tocopherol, i.e., vitamin E. In such mixtures, solubilized AP can act competitively to protect alpha-tocopherol from premature oxidation in dietary supplements as well as foods. Monoglycerides and lecithin are often combined with AP to increase its solubility, which in fat is approximately 300-500 ppm (5 mg/10 g). The combination of AP, tocopherols and lecithin has proven particularly effective in protecting fats, e.g., deep-frying fats, and vegetable oils from oxidation. For example, AP is more effective than BHA and BHT, and is particularly effective at a level of 200 ppm, in controlling oxidative color development in deep-frying fats and oils over a 5-10 day frying period. AP has also been used in fat-containing dairy products such as in the manufacture of dried whole milk to prevent the milk fat from developing off-flavors over a 6-12 month period.

Perricone et al., U.S. Pat. No. 6,162,419, describes the use of certain non-aqueous solvents to stabilize ascorbyl compositions that include fatty acid esters of ascorbic acid such as AP, their salts, and ascorbic acid and its salts. These non-aqueous solvents provide greater stability and solubility than aqueous systems. Some of these solvents such as propylene glycol and glycerin may be used for preparing concentrated solutions of vitamin C and AP, and could be added in very small amounts to beverages. However, upon dilution into an aqueous beverage or processed food product of the present invention, the stabilizing effect of the solvent is lost.

Ghosal in U.S. Pat. No. 6,235,721 describes a natural antioxidant blend that combines vitamin C with an extract of Emblica officinalis fruit containing a mixture of phenolic antioxidants. Gholsal reports stabilization of the vitamin C, but use of the phenolic composition would not be desirable in the present invention, and the composition does not combine AP with vitamin C.

While AP is essentially insoluble in water, it has been introduced as a sacrificial antioxidant into some aqueous foods and beverages together with vitamin C by including a small amount of edible solvent, e.g., solubilizing fat or added ethanol that acts as a co-solvent to dissolve the AP. For example, Monte in U.S. Pat. No. 5,141,758 describes the fortification of beverages with water-soluble vitamin C (e.g., ascorbic acid, sodium or calcium ascorbate) in which a relatively small amount of solvent-dissolved AP is added to the beverage to extend the shelf life of the vitamin C in the presence of air.

### SUMMARY OF THE INVENTION

The present invention relates to compositions and methods for stabilizing vitamin C in certain aqueous beverages and foods in which vitamin C would otherwise be substantially degraded, e.g., during heat-pasteurization, exposure to light, and/or extended storage. It was discovered that the water soluble vitamin C (ws-vitC) can be stabilized against oxidation in an aqueous medium by adding water-insoluble microparticulate ascorbyl palmitate (mAP), where the microparticulate ascorbyl palmitate is maintained in a substantially undissolved state, e.g., as a suspension, in the product. The invention allows food and beverage manufacturers to provide a nutritionally functional level of vitamin C, with its accompanying benefits, over the lifetime of many different water-containing foods and beverages such as cows milk, soy milk, other beverages, soups, sauces, juices, and the like.

Thus, in a first aspect, the invention concerns a vitamin C-fortified processed aqueous food or beverage composition for human or animal consumption, in which the composition includes at least one edible water-solubilized chemical source of vitamin C (termed or “ws-vitC” or “source 1”) and at least one edible microparticulate and water-insoluble chemical source of ascorbate (termed “i-vitC” or “source 2”), in which the ws-vitC and the i-vitC are both dispersed in the composition that is free of an amount of available solvent that would dissolve the i-vit C (source 2), and where the i-vitC acts to reduce the rate of loss of vitamin C in the composition.

In particular embodiments, the ws-vitC (source 1) is ascorbic acid, sodium ascorbate, potassium ascorbate, calcium ascorbate, or any combination thereof.

In particular embodiments, the i-vitC (source 2) is ascorbyl palmitate, ascorbyl stearate, one or more fatty acid esters of ascorbic acid, one or more fatty acid esters of ascorbic acid where the fatty acid moiety of the ester is different from palmitate or stearate, or any combination thereof; the i-vitC is or includes ascorbyl palmitate.

In advantageous embodiments, the weight average diameter of the microparticles of source 2 is 1 to 100, 1 to 50, 1 to 30, 5 to 50, 5 to 30, 5 to 25, 8 to 100, 8 to 50, 8 to 25, 10 to 100, 10 to 50 microns, 10 to 30, 10 to 25, 15 to 100, to 50, 15 to 30, 20 to 100, 20 to 50, 30 to 100, 30 to 50, or 50 to 100 microns, e.g., for microparticles which are or include ascorbyl palmitate or ascorbyl stearate.

In preferred embodiments, the composition is free of an amount of ethyl alcohol that will dissolve the microparticles of i-vitC; the composition is free of an amount of mono-glycerides, diglycerides, and/or triglycerides that will dissolve the microparticles of i-vitC; the composition is free of an amount of available solvent which will dissolve the microparticles of i-vitC.

In particular embodiments, the ws-vitC and i-vitC are combined in a weight ratio of ws-vitC to i-vitC in a range of 1:1 to 100:1, 1:1 to 50:1, 1:1 to 20:1, 1:1 to 10:1, 2:1 to 100:1, 2:1 to 50:1, 2:1 to 20:1, 2:1 to 10:1, 5:1 to 100:1, 5:1 to 50:1, 5:1 to 25:1, 5:1 to 15:1, 10:1 to 100:1, 10:1 to 50:1, 10:1 to 25:1, or 10:1 to 15:1.

In particular embodiments, the amount of ws-vitC included in a standard serving of a processed aqueous food or beverage product is sufficient to provide at least 5, 7, 10, 15, 20, 25, 30, 40, or 50% of the recommended daily intake (RDI) of vitamin C throughout the shelf life of the product.

In particular embodiments, the composition is a processed beverage selected from soy milks, cows milks, ready to drink fruit juices and smoothies, ready to drink vegetable juices, tea-containing beverages, coffee-containing beverages, carbonated beverages, and combinations thereof.

In particular embodiments, the vitamin C-fortified processed aqueous food or beverage composition is packaged in a container that is essentially opaque to light that would otherwise prematurely degrade the vitamin C of source 1 over the shelf life of the product.

In another aspect of the present invention, a method is provided for protecting vitamin C in a vitamin C-fortified processed aqueous food or beverage composition for human or animal consumption. The method includes dispersing at least one edible water-soluble chemical source of vitamin C (ws-vitC or equivalently source 1) and at least one edible microparticulate water-insoluble chemical source of ascorbate (i-vitC or equivalently source 2) in the food or beverage composition, in which the composition is free of an amount of available solvent that would dissolve the i-vitC, and in which the i-vitC acts to reduce the rate of loss of vitamin C in the composition.

In particular embodiments, the above method utilizes components or provides compositions as specified for any of the embodiments listed above for the preceding aspect or otherwise described herein for the invention.

In a related aspect, the invention concerns a dry preparation which includes water soluble vitamin C (ws-vitC) and an equal or lesser amount by weight of microparticulate water-insoluble (and usually oil-soluble) vitamin C (i-vitC, e.g., mAP).

In particular embodiments, the chemical species of the ws-vitC and/or i-vitC, respective amounts or ratio of ws-vitC and i-vitC, and/or the physical form of the ws-vitC and/or i-vitC is as specified for an above aspect or embodiment thereof or otherwise specified herein for the present invention.

In particular embodiments, the dry preparation is packaged in single-use packaging suitable for preparing a single serving or a single meal amount of a food or beverage composition.

Another related aspect concerns a method for an individual to extend the time period of blood absorption of active vitamin C in their body from an ingested vitamin C-fortified processed aqueous food or beverage composition by providing and ingesting the food or beverage composition, where the composition includes at least one water-soluble chemical source of vitamin C (ws-vitC) and at least one unoxidized water-insoluble microparticulate chemical source of ascorbate (i-vitC) dispersed in the food or beverage composition. Both the ws-vitC and the unoxidized i-vitC are present in nutritionally significant amounts. The composition is free of an amount of available solvent that would dissolve the i-vitC. The i-vitC acts to reduce the rate of loss of vitamin C in the composition. Highly preferably, the weight ratio of ws-vitC to i-vitC is in a range of 1:1 to 20:1 (e.g., 1:1 to 10:1, 1:1 to 5:1, 1:1 to 4:1, 1:1 to 3:1, 1:1 to 2:1, 2:1 to 20:1, 2:1 to 10:1, 2:1, to 5:1, 2:1 to 4:1, 2:1 to 3:1, 3:1 to 20:1, 3:1 to 10:1, 3:1 to 5:1, 3:1 to 4:1, 5:1 to 20:1, or 5:1 to 10:1), although the level of i-vitC may be higher than 1:1 but at higher cost. Similarly, the invention concerns a method to assist an individual to exend the time period of absorption of vitamin C from a vitamin C-fortified processed aqueous food or beverage composition as just specified, by providing the food or beverage to an individual for ingestion.

Also highly preferably, the food or beverage composition is or is in a food or beverage product, and the nutritionally significant amounts of both the ws-vitC and the unoxidized i-vitC are present throughout the shelf life of the product.

In particular embodiments, the ws-vitC and/or the i-vitC are as specified for an aspect above or otherwise specified herein for the present invention and/or the food or beverage product supplies at least 10, 20, 30, 40, or 50% of the RDI per serving throughout the shelf life of the product.

In this composition, the microparticulate i-vitC serves to protect the ws-vitC against oxidation, and residual particulate i-vitC is more slowly absorbed than the ws-vitC, thereby extending the period of vitamin C absorption by the individual.

Additional embodiments will be apparent from the Detailed Description and from the claims.

### DETAILED DESCRIPTION OF THE PREFERRED EMBODIMENTS

### Introduction and General Description

As described in the Summary above, the present invention concerns the supplementation (fortification) of processed foods and beverages with vitamin C in a manner such that vitamin C dissolved in an aqueous solution or suspension (i.e., an aqueous medium) is protected against oxidative degradation. In general, this involves the joint inclusion of a dissolved water-soluble vitamin C (ws-vitC) and a water-insoluble chemical derivative of vitamin C (i-vitC) in the aqueous medium. This combination can be used during the manufacture and storage of processed foods and beverages to better preserve useful levels of vitamin C in such products. A very useful i-vitC derivative is ascorbyl palmitate (abbreviated herein as AP), also referred to as vitamin C palmitate (abbreviated herein as vitCP). The particularly useful microparticulate form of AP is abbreviated herein as mAP or alternatively vitCP-m.

With one of the principal objectives of the present invention being to preserve vitamin C activity in foods and beverages, it is important to understand the definition of vitamin C and “vitamin C activity.” The definition of these terms not only includes ascorbic acid, its water-soluble salts and any ascorbic acid activity released from ascorbyl esters, e.g., ascorbyl palmitate, during gastrointestinal digestion, but also includes dehydroascorbic acid and its salts, because this partially oxidized vitamin C metabolite produced in vivo still possesses vitamin C biological activity.

It is understood that vitamin C may be added to a processed food as either a micronutrient or as a sacrificial antioxidant to aid in food-preservation. The present invention is primarily directed to the former, i.e., the nutritional use of vitamin C. Vitamin C (also referred to as ascorbic acid or a salt thereof) and larger molecular weight derivatives of vitamin C are commercially available in either water-soluble or water-insoluble/fat-soluble chemical forms. Normally, when aqueous foods and beverages are supplemented with vitamin C for dietary purposes, ascorbic acid and sodium, potassium, and/or calcium salt forms of ascorbic acid that are highly soluble in water are utilized. However, for protection of fatty foods such as flax seed oil or fish oil against oxidative rancidity, ascorbyl palmitate, that is soluble in fat but insoluble in water, is frequently selected as a sacrificial antioxidant.

It is common to see nutritional labels on food and beverage packages claiming to provide between 10% and 100% or more per serving of the daily value of vitamin C (60 mg). Such processed foods typically provide vitamin C as simple ascorbic acid or as a salt of ascorbic acid. Unfortunately, most if not all of these vitamin C supplements in foods tend to be highly susceptible to oxidative degradation. For example, it has been shown that when vitamin C (as free ascorbic acid) has been added to milk and pasteurized, it tends to be extensively degraded during 3 to 4 weeks storage in conventional laminated cartons even when the cartons are stored in the dark [Gliguem et al., J. Dairy Sci., 88:891-899 (2005)].

To address this problem, a variety of different physical and chemical methods have been used to stabilize and/or protect aqueous vitamin C solutions from premature oxidative degradation. These have included the use of light-blocking bottles to reduce the rate of photo-oxidation of vitamin C and the use of layered containers in which one or more layers serve as barriers to oxygen entry via diffusion. Several chemistries that might help stabilize vitamin C have also been investigated to some degree, including mixed phase emulsions, sacrificial phenolic antioxidants, and non-aqueous solvent-dissolved AP.

As indicated above, water-solubilized vitamin C and fat-solubilized AP have been previously added to processed food and beverage products at low levels as sacrificial antioxidants. Typically, these levels are in the range of about 200-500 ppm. For AP its solubility limit in fat is approximately 300 ppm.

While AP is useful in fats as a sacrificial antioxidant at a level of approximately 300 ppm, AP has not been typically viewed as a useful micronutrient source of vitamin C because of its lack of solubility in water, its limited solublility in oil, and its high cost (about 5-6-fold more expensive than vitamin C based on ascorbic acid content). As a micronutrient, vitamin C is required at substantially higher levels in food and beverage products than when used as a sacrificial antioxidant. In fact, approximately 1 g of Vitamin C is soluble in approximately 3 g water, and it is frequently added to processed foods and beverages at substantial levels. For example, if Vitamin C is added to a 30 g serving of cereal at a level of 60 mg (100% of the Daily Value), the Vitamin C is being added at a level of 2000 ppm. By contrast, AP is essentially insoluble in water and has only limited solubility in fat (i.e., approximately 300 ppm), so it is difficult or impossible to practically add sufficient dissolved AP to a food or beverage composition to be useful for nutrient purpose. This is because a typical quantity of fat, e.g., 10 g, present in a serving of fatty food, e.g., margarine, when saturated with AP would contain only 3 mg AP. This represents only about 2% of the vitamin's Daily Value (140 mg AP). Therefore, one would need to eat 100 g of fat saturated with AP in order to reach a level of only 20% of the Daily Value. In summary, if AP has been previously used as a micronutrient, its use has been extremely limited to the best of Applicant's knowledge.

Further with regard to the use of AP, Applicant is unaware of any prior research in which an aqueous food or beverage composition or product supplemented with a water-soluble form of vitamin C has also been supplemented with AP (or other i-vitC) that is maintained in an essentially insoluble state in the composition (such as a dispersion of AP microparticles that is maintained substantially free of available solubilizing agent, i.e., free of an amount sufficient to dissolve the AP). Remarkably, it has now been discovered that insoluble AP, as a microparticulate suspension, can function to protect water-solubilized vitamin C (ws-vitC) from premature oxidative degradation. This unlikely combination of soluble and insoluble antioxidants is at the core of the present invention.

The present invention, which involves utilizing insoluble microparticulate AP (i.e., AP without an amount of available AP-solubilizing agent effective to dissolve the AP microparticles), differs markedly from that of Monte, U.S. Pat. No. 5,141,758, where solvent-dissolved AP was reported to protect vitamin C. As described in Monte, the AP was dissolved in a solvent such as aqueous ethanol and/or the beverage contained a “host” such as fat in which the AP is dissolved (col. 2, line 16).

This is reflected further in the description, e.g., at column 8, lines 33-45, where Monte states, “In the foregoing [thirty-two] examples, when ascorbyl palmitate is mixed into liquid drinks, the ascorbyl palmitate was in combination with a[n] aqueous ethanol solution containing 10% by weight ascorbyl palmitate. . . . If the drink contains small amounts of ethanol or another chemical components which dissolves ascorbyl palmitate, then the ascorbyl palmitate can, if desired, be added directly to the drink without first dissolving the ascorbyl palmitate in an aqueous ethanol solution”, e.g., as a powdered pre-mix of AP with other vitamins. Claim 1 is consistent with this description, specifying a fruit juice composition containing 0.001 to 1.0% fat, i.e., the fat acts as the AP-dissolving component. By contrast, the present invention relies upon the combined use of solubilized vitamin C and non-solubilized microparticulate AP (herein abbreviated “mAP”) in aqueous food and beverage products, in which the products are substantially free of available AP-solubilizing agents (i.e., free of an amount of available AP solvent that could dissolve the AP). In addition, the tests and test results reported in Monte present difficulties in interpretation. In particular, Monte reports in the examples that the test solutions (e.g., milk and apple juice) were stored in a refrigerator for periods of time which were commonly up to several months (e.g., as stated for Examples 2 and 4). Normal practical experience suggests that over such extended storage periods with open containers in a refrigerator, the solutions would frequently experience bacterial and/or fungal contamination, with the potential for microbial production of vitamin C or other unknown effects on vitamin C levels. In addition, over such long storage periods, it appears likely substantial evaporation would occur. Therefore, in the absence of description of the conditions of the media and how the vitamin C was analyzed, it is difficult to understand the tests and to interpret and credit the reported results.

The AP microparticles appear to have a specific gravity just slightly greater than 1.00 allowing them to remain suspended in aqueous beverages and aqueous food components for substantial periods of time before settling. This substantially neutral density allows the mAP to be conveniently combined and utilized in many different beverages and foods without encountering settling problems. The particulate mAP may be prepared methods known in the art of manufacturing microparticulate material, e.g., via spray-drying of aerosolized solutions of AP to form microparticulate dried powders, or via milling AP solids to form AP microparticulates.

In accordance with the description above, vitamin C as used in the present invention is principally used for its nutritional properties rather than for its food-preserving properties, and is provided in a water-soluble form protected against oxidative degradation by the presence of a microparticulate fat-soluble/water-insoluble form of vitamin C, e.g., as vitamin C palmitate, that is principally maintained insoluble and suspended as microparticles in the aqueous portion of a food or beverage such as milk. The microparticulate ascorbyl palmitate is dispersed and provides a protective function for the water-solubilized vitamin C.

While the fat-soluble/water-insoluble microparticulate vitamin C derivative is primarily included in the aqueous component for its protective effect on the water-soluble vitamin C, it also can supplement the amount of vitamin C available for uptake in the digestive tract. Indeed, the water-insoluble vitamin C may provide an advantage by spreading the absorption period of vitamin C by the body. Once ingested, esterases that are present in the gastrointestinal tract can remove the palmitic acid residue, releasing free ascorbic acid that is absorbed into the bloodstream. The scientific literature suggests that ingesting vitamin C as ascorbyl palmitate rather than free ascorbic acid provides more gradual release and more sustained absorption of the vitamin C in the GI tract. The release and uptake rates can vary depending upon the nature of the food vehicle carrying the mAP and the level of digestive lipases. This advantage complements the increased oxidative stability provided by microparticulate ascorbyl palmitate to the water-solubilized ascorbic acid in aqueous foods and beverages.

Development of Invention

Applicant's initial goal was to fortify skim cows milk with stabilized vitamin C, to provide the consumer with at least 10% and preferably at least 20% of the RDI of vitamin C (20%×60 mg=12 mg ascorbic acid) per standard 8 ounce serving of milk. While Applicant initially attempted to use solubilized AP-containing compositions similar to those of Monte to stabilize vitamin C in milk, the resulting compositions did not provide vitamin C stabilization. That is, the vitamin C stability results failed to reproduce the results reported by Monte. More specifically, solubilized ascorbyl palmitate (AP) was added to skim cows milk either as a commercial preparation of 10% by weight AP dissolved in a mixture of mono- and diglycerides plus propylene glycol (Kemin, Inc.), or as a laboratory preparation of 10% by weight AP dissolved in 100% grain ethanol. Each of these AP solutions were added to the skim milk either alone at a level of 21 mg per 8 oz. serving (equivalent to 9 mg ascorbic acid/serving), or together with water-soluble ascorbic acid (as calcium ascorbate, dihydrate) in a weight ratio of approximately 9 parts ascorbic acid to 1 part AP to provide 24 mg ascorbic acid/serving (40% of RDI).

An additional and otherwise identical calcium ascorbate, dihydrate-containing skim milk was prepared except that non-solubilized microparticulate ascorbyl palmitate was added (i.e., mAP obtained from DSM Nutritional Products, Parsippany, N.J. rather than solubilized AP). Again, the same 9:1 ratio of weight equivalents ascorbic acid to mAP was added to the milk. The mAP-containing milk lacked any solvent/co-solvent that could dissolve the mAP.

All of the above milks were UHT-pasteurized, aseptically packaged in half gallon Tetra Pak Freshcoat® milk cartons (Vernon Hills, Ill.), and refrigerated at 4° C. either in the dark or under cool white fluorescent artificial lighting. The Freshcoat® milk cartons consist of a 5-layer structure that includes, from outside to inside: low density polyethylene (LDPE), paperboard, nylon, a tie layer, and LDPE.

Results were as follows for milks packaged and sealed in the above-described milk cartons that were exposed to artificial lighting (see above): Pre-solubilized AP preparations added alone to milk were unstable and decomposed rapidly over time. When combined with water-soluble ascorbic acid in milk, these presolubilized AP preparations had no measurable effect in sustaining the level of water-soluble vitamin C (regardless of whether the vitamin C was added as ascorbic acid or calcium ascorbate). In fact, when compared to cartons of the same vitamin C-fortified skim cows milk that lacked AP (the “control” milk), neither the ethanol-solubilized AP nor the mono- and diglyceride-solubilized AP measurably affected the amount of vitamin C surviving over time.

Remarkably, however, (and in contrast to the results for pre-solubilized AP described above), when mAP material (obtained from DSM Nutritional Products) was added and maintained in an insoluble microparticulate condition in an otherwise identical milk containing the same level of water-soluble vitamin C, the mAP significantly protected the vitamin C activity level over time. This observation was unanticipated in light of Monte in U.S. Pat. No. 5,141,758 who reported that vitamin C-fortified beverages were protected by supplementation with solubilized AP when stored in open containers in a refrigerator. This mode of storage is very differently from the UHT pasteurized and sealed carton storage of beverages described herein. More specifically, Applicant herein describes measurements of vitamin C levels in vitamin C-fortified milks containing insoluble AP, that are furthermore stored in sealed airtight refrigerated cartons. Milks were subjected to commercial processing including high temperature pasteurization (UHT) and homogenization, and the milk in cartons was subjected to extended refrigerated storage and fluorescent lighting in sealed cartons.

It has become evident that the utility and functionality of the mAP material (e.g., as obtained from DSM Nutritional Products, Parsippany, N.J.) depend upon the mAP remaining insoluble in milk and any other beverages and foods fortified with vitamin C. As a corollary, it is important that the food or beverage that serves as carrier for the mAP remain substantially free of an amount of an available solvent that would otherwise dissolve the mAP.

Insoluble Vitamin C Microparticles and Use in Food or Beverage Compositions for Protecting Water Soluble Vitamin C

Analysis of the particle size distribution of DSM's mAP material suspended in an aqueous solution containing 1% dissolved sodium lauryl sulfate (to prevent particle clumping) revealed a weight average diameter of about 15 microns with approximately 50% of the material ranging between 5 and 30 microns. The mAP material in this size range is shown herein to be effective at protecting water-solubilized vitamin C. It is believed that the greatest protective effect is provided when the mAP (or other water-insoluble vitamin C) microparticles are not excessively small. Thus, most often microparticles having weight average diameters above about 5, 8, 10, 15, 20, or 25 microns are preferred. Without being bound by theory, it is hypothesized that very small particles, e.g., sub-micron particles are less effective in protecting ws-vitC because the very small particles behave in the system similarly to fully dissolved molecules, with the ascorbyl moieties excessively available to oxidation. The weight average diameter and/or the particle size distribution can empirically tested to optimize protection of the ws-vitC, e.g., for a particular application.

In the present invention, a vitamin C-fortified food or beverage product is preferably supplemented with at least 6 mg, preferably at least 12 mg, and more preferably at least 24 mg ascorbic acid per normal serving to provide at least 10%, 20% or 40% of the Recommended Daily Intake (RDI) of vitamin C (current RDI=60 mg ascorbic acid). A chemically equivalent amount of calcium, sodium or potassium ascorbate or other water-soluble form of vitamin C can be beneficially used. Along with the water-soluble vitamin C, the amount by weight of non-solubilized mAP (and/or other i-vitC) added to the food or beverage product to stabilize the water-soluble vitamin C ranges from 1% to 100% of the amount by weight of vitamin C added to the food or beverage (based on ascorbic acid equivalents). More typically, the amount of mAP ranges from 5% to 25% of the amount of water-soluble vitamin C. Applicant has often utilized an amount of mAP approximately equal to 10% of the amount of vitamin C added to a food or beverage. In combination, water-soluble vitamin C and mAP can provide and maintain a substantially constant level of vitamin C in a beverage over the product's lifetime, or at least levels which are significantly higher than the levels which would be observed in the absence of the mAP.

To allow for some loss of vitamin C during UHT pasteurization and later storage, Applicant has, for example, initially added levels of up to 40% of the 60 mg RDI level of vitamin C per serving of milk so as to assure a final level of at least 20% of the RDI at the end of the shelf life of the milk. Thus, for example, Applicant has combined 29 mg of water-soluble calcium ascorbate dihydrate (equivalent to 27 mg of calcium ascorbate or 24 mg of ascorbic acid) together with approximately 3 mg of insoluble mAP per serving of skim cows milk, and pasteurized and homogenized the milk. The milk was aseptically filled, sealed, and stored at 4° C. in an essentially airtight container (5 layered Tetra-Pak 0.5 gallon gable-top milk cartons). Essentially no natural or artificial light entered the container because it was stored in the dark. In fact, after a 7 week period of storage, and including the loss of vitamin C during UHT pasteurization, only a 29% overall loss of vitamin C activity was measured. More specifically, 21 mg of the original 29 mg dose of calcium ascorbate dihydrate, i.e., 71%, remained after 7 weeks of storage. All vitamin C levels reported herein include ascorbic plus dehydroascorbic acids (both are biologically active), and were measured by an independent testing laboratory (NP Analytical Laboratories, St. Louis, Mo.). In fact, their assay converts all ascorbate to dehydroascorbate for measurement.

When the same milk production process described above was duplicated except that the insoluble mAP was replaced with the same quantity of solubilized AP contained in a fatty vehicle, the vitamin C stability results were substantially different. The solubilized AP utilized in these experiments was obtained from Kemin AgriFoods North America, Inc. (Des Moines, Iowa), and was provided in a solution containing 55% by weight mono- and diglycerides, 35% propylene glycol, and 10% AP. It should be noted that the AP remains dissolved in the mono- and diglyceride component of the vehicle when this vehicle is dispersed in milk because the vehicle is immiscible in aqueous milk. After the same 7 weeks of milk storage in the dark only 40% rather than 71% of the original 29 mg dose of calcium ascorbate dihydrate remained.

This differential result (40% versus the 71% reported above) is remarkable. It was anticipated that a solubilized AP antioxidant agent, whose molecules are much more mobile and diffusible than those in a microparticulate solid, would be more effective as a sacrificial antioxidant agent for protecting vitamin C in milk, than insoluble/non-diffusible AP molecules residing within solid microparticles of AP. However, the opposite is true, and it has been concluded that an unanticipated reaction mechanism is involved, by which soluble vitamin C can interact with insoluble mAP to gain protection.

The same milk assembling, aseptic filling, and sealing process described above was used. In fact, identical half gallon cartons of milk from the same production run as above, and containing identical amounts of calcium ascorbate dihydrate (29 mg per serving), and identical amounts of either pre-solubilized AP (from Kemin Agri Foods North America, Inc.) or insoluble mAP (from DSM Nutritional Products, Inc.) described above were used. “Control” milk lacking any AP but containing the same amount of calcium ascorbate dihydrate was also prepared. All milk cartons were identically handled and again stored at 4° C. except this time the cartons were continuously exposed to cool white fluorescent light in a cooler rather than being stored in the dark. Sealed cartons were opened at 4 weeks and at 7 weeks for vitamin C analysis. The results of these analyses provided an immediate indication that enough light was penetrating the Tetra-Pak milk cartons to cause significant degradation of the levels of vitamin C in skim milk. While the insoluble mAP again provided the best protection for vitamin C, substantial losses of vitamin C were experienced in the mAP+vitamin C-containing milk in the Tetra-Pak containers. More specifically, after 4 weeks of exposure to the fluorescent light, 50% of the vitamin C originally added to the mAP-containing skim milk remained undegraded. However, only approximately 35% of the originally added vitamin C level remained in the “control” milk cartons (containing only vitamin C) as well as in the cartons containing vitamin C plus the solubilized AP from Kemin, Inc. That is, the solubilized AP provided no protection for the vitamin C above that existing in the skim milk lacking AP. After 7 weeks of exposure to the same fluorescent light, further degradation was measured in unopened cartons. In the mAP-containing milk, almost 36% of the vitamin C remained, while in the solubilized AP-containing milk, 22% of the vitamin C remained undegraded, and in the “control” AP-free milk, 21% of the vitamin C remained undegraded. Therefore, mAP provides a level of protection for vitamin C exposed to fluorescent light, whereas solubilized AP provides either no or negligible protection.

The susceptibility of vitamin C levels in milk to losses during heat sterilization, and owing to oxygen-permeable packaging and/or daylight exposure is investigated and demonstrated in a publication by Gliguem et al. (J. Dairy Sci., 88: 891-899, 2005) entitled “Effects of Sterilization, Packaging, and Storage on Vitamin C Degradation, Protein Denaturation, and Glycation in Fortified Milks.” This article points out that the vitamin C contained in milk can remain very susceptible to degradation following packaging as Applicant has demonstrated above. It is evident from the results described herein that vitamin C levels in milk may be partially stabilized by addition of AP as insoluble microparticles, e.g., mAP, but that other protective measures can beneficially also be taken to protect the milk and the vitamin C contained within. Oxygen exposure and light exposure should be minimized. It is apparent that the small amount of fluorescent light leaking through the walls of Tetra-Pak containers is sufficient to cause significant losses in vitamin C when compared with milk packaged in the same containers but stored in total darkness. Applicant's data indicate that a combination of improved container opacity to light together with use of mAP substantially improves vitamin C stability in milk. While not measured in these experiments, the exclusion of air/oxygen may also play a significant role in protecting the vitamin C.

Without being bound or limited by theory, it is hypothesized that a novel chemical interaction may occur between solubilized vitamin C molecules and non-solubilized ascorbyl palmitate microparticles dispersed in aqueous foods and beverages. This chemical interaction would result in a decrease in the rate of oxidation of native vitamin C, and/or a decrease in the rate of oxidation of dehydroascorbic acid, since the latter is still biologically active as vitamin C. For example, dehydroascorbic acid may be chemically or biochemically reduced back to native vitamin C. There is ample precedent for catalytic oxidation-reduction reactions occurring between solid state catalysts and liquid phase reactants. It is possible that insoluble ascorbyl palmitate may act as a catalyst with solubilized ascorbic acid to form an oxidation-reduction couple. More specifically, ascorbic acid and/or dehydroascorbic, that is in the process of being oxidized, may interact with microparticles of ascorbyl palmitate, and be reduced to one of the biologically active forms of vitamin C, i.e., ascorbic acid or dehydroascorbic acid.

For the purposes of defining the scope of the present invention, it is clearly intended that other water-insoluble derivatives of vitamin C may be used that will protect soluble vitamin C from premature oxidation, and that may be substituted for or used with ascorbyl palmitate. Furthermore, it is believed that the size of ascorbyl palmitate (and/or other water insoluble vitamin C derivative) microparticles may be adjusted to improve and/or optimize their chemical efficacy and possibly their longevity in protecting vitamin C in solution.

Applicant is unaware of any prior art that describes a water-insoluble chemical derivative of vitamin C such as AP that can be used in its solid state as a microparticulate antioxidant, reducing agent, or catalyst suspended in aqueous solutions, to protect solubilized vitamin C. While the mechanism of protection may differ, ascorbyl palmitate may be used in place of less desirable fully synthetic antioxidants such as TBHQ to protect water-soluble vitamin C.

For the purpose of biochemical efficacy, so that the water-insoluble chemical derivatives of vitamin C described herein, such as ascorbyl palmitate (AP), will remain in aqueous suspension in beverages and food as long as possible, the AP is preferably provided as a fine microparticulate material. This mAP material may be combined as a dry powder (diameter ≦100 microns) with a dry powdered source of water-soluble vitamin C. Optional excipients, such as a surfactant and an anti-caking agent, may be added to the dry blend to facilitate later aqueous dispersal of the powder.

### Product Applications

Numerous applications exist for the present combinations of water-soluble sources of vitamin C (abbreviated “ws-vitC” or “source 1” herein) and microparticulate water-insoluble (but water-dispersible) derivatives of vitamin C (also termed “water-insoluble chemical sources of ascorbate” or abbreviated “i-vitC or “source 2” herein) in the areas of foods, beverages, dietary supplements and pharmaceuticals.

The present combination of mAP (and/or other i-vitC) microparticles and vitamin C can be used in many different types of aqueous solutions and/or suspensions, as well as in a wide variety of foods, that are prepared using such aqueous solutions and suspensions. For example, the combination may be used in liquids such as water (e.g., plain, flavored, or fortified), fruit and/or vegetable juices and juice blends (e.g., orange, apple, cranberry, grape, raspberry, blueberry, and carrot juices as well as other fruit and/or vegetable juices and juice blends) steeped or brewed beverages (such as coffee, tea, and herbal teas), milk, dairy products containing significant amounts of water (e.g., yoghurt, cottage cheese, cheese), apple sauce, canned fruits, foods which are cooked using water or other aqueous liquid as an ingredient (e.g., soups, stews, mashed potatoes, refried beans, pasta, rice, and the like, or can be added to foods which contain significant amounts of water (e.g., raw eggs, which can then be used in essentially any manner for which raw eggs are suitable).

Formulated as a dry powder blend that is readily dispersible in water as described herein, the combination of water-soluble (source 1) and water-insoluble (source 2) can be packaged in pre-measured quantities of powder. The powders may also be readily combined with other edible powders such as powder drink mixes, dry soup mixes, non-dairy coffee creamer and/or natural or artificial sweetener (e.g., sucralose or aspartame). Alternatively, larger quantities of the dry powder blends may be used in the commercial production of processed foods and beverages that require supplementation with vitamin C.

### DEFINITIONS

The following definitions of terms are provided to assist the understanding of the reader. For terms that are not defined below, the common definition is assumed as provided in the current edition of Webster's International Dictionary or alternatively if not provided in the Webster's International Dictionary, as provided in a standard organic chemistry textbook such as Organic Chemistry (5^{th} Edition) by Leroy Wade (Prentice-Hall, Inc). As used in this description and the accompanying claims, the following terms shall have the meanings indicated, unless the context requires otherwise.

In connection with the present compositions, the term “water soluble” or “water-solubilized” as it relates to a chemical source of vitamin C means that at least one equivalent of the RDI (recommended daily intake) of vitamin C (e.g., 60 mg ascorbic acid) will dissolve in 240 grams of water or an aqueous beverage composition at 70 degrees F.

The term “microparticulate” as it relates to ascorbate refers to a finely divided solid form of ascorbate in which the average particle diameter is smaller than 0.1 mm (100 microns), commonly ranging between about 1 micron and 100 microns. In particular useful preparations of microparticulate ascorbate, the average particle diameter is in a range of 10-100, 10-70 10-50, 10-30, 15-100, 15-70, 15-50, 15-30, 30-100, 30-70, or 30-50 microns.

The term “water-insoluble” as used in connection with chemical forms of ascorbate and microparticles thereof refers to a water-insoluble edible chemical derivative of ascorbic acid such as ascorbyl palmitate or ascorbyl stearate that is essentially insoluble in water at a temperature of 70° F. In the present context, water-insoluble means that less than 6 mg of the ascorbyl derivative will dissolve in 240 ml of water or in a standard serving of a food or beverage, e.g., 240 ml of a beverage at a temperature of 70° F. To assure the beneficial presence of a sufficient amount of an insoluble derivative of ascorbate, the food or beverage is maintained substantially free of an amount of available solvent, e.g., alcohols, glycols, fats and glycerides, that could dissolve the water-insoluble derivative of ascorbic acid.

As used in connection with the present compositions, the term “available solvent” refers to solvent which is accessible to the microparticulate water-insoluble vitamin C. Thus, bulk edible oil in which microparticles are suspended will be “available solvent” while typically edible oil in protein coated microdroplets suspended in an aqueous solution will not be available to dissolve i-vitC suspended in the aqueous solution because the oil is substantially sequested from the microparticles by the protein droplet coating.

As used herein, the phrases “available solvent which will dissolve the microparticles” and “an amount of available solvent which will dissolve the microparticles” and “an amount of solvent which will dissolve the microparticles” and like phrases mean that a solvent would be present in a relevant aqueous composition in an amount and/or in a chemically and physically available form which will dissolve a sufficient portion of the microparticulate i-vitC (e.g., microparticulate ascorbyl palmitate) to substantially reduce the effectiveness of the microparticulate i-vitC required to protect the ws-vitC. Conversely, indication that a composition is free or substantially free of available solvent which would otherwise dissolve the microparticles of i-vitC (as will as similar phrases) means the solvent present in a relevant aqueous composition will not dissolve a sufficient portion of the microparticulate i-vitC to substantially reduce the effectiveness of the microparticulate i-vitC in protecting the ws-vitC. For food and beverage compositions free of such available solvent, the solvent will not dissolve the microparticulate i-vitC at least over the normal shelf life of the food or beverage composition. Preferably any such solvent in the composition will dissolve no more than 30%, more preferably no more than 20%, and still more preferably no more than 10%, 5%, 3%, 2%, or even 1% of the microparticulate i-vitC over the normal shelf life of the food or beverage composition. As previously indicated, the failure of the solvent to dissolve the microparticulate i-vitC may be due to an insufficient amount of the solvent being present and/or the solvent being present in a substantially inaccessible form (e.g., in the form of protein coated microdroplets or in the form of solid fat particles).

For weight ratios and relative amounts of ws-vitC and i-vitC (e.g., AP), the ratios and relative amounts are determined based on the respective ascorbic acid equivalent weights. The ascorbic acid equivalent weight is the weight of the ascorbyl moieties in a sample (in the acid form), excluding the weights of other moieties. For example, the ascorbic acid equivalent weight of a sample of AP is the weight of the ascorbyl moieties as if they were separated from the palmitic acid moieties.

The term “vitamin C-fortified” means that an exogenous source of vitamin C is selected and added to the processed food or beverage in an amount that has nutritional and biological significance. Preferably, vitamin C fortification involves adding at least 10% and preferably 20% of the current RDI of vitamin C (60 mg ascorbic acid) to a serving of food or beverage. Any one, or any mixture, of different edible chemical sources of vitamin C, e.g., ascorbic acid, calcium ascorbate, sodium ascorbate, and the like, as described elsewhere herein may be used to fortify foods and beverages.

The term “aqueous food or beverage” as it relates to human and animal (pet and livestock) nutrition refers to the liquid content of edible solid, liquid and mixed solid and liquid compositions being primarily water-based.

The term “essentially opaque to light” as it applies to a container that holds a processed aqueous food or beverage product that has been fortified with vitamin C means that the container blocks at least 90%, preferably 95%, and more preferably 99% of incident sunlight. In cows milk-based beverages, loss of vitamin C attributable to natural and artificial visible and UV light exposure is believed to be greatly reduced at wavelengths corresponding to red light. Therefore, if a degree of visual transparency is desirable in certain containers, then containers that block UV light as well as the lower wavelengths of visible light, but selectively transmit red light may be compatible with (although not necessary sufficient for) sustaining vitamin C levels in vitamin C-fortified milk.

For referring to the sizes of particles or microparticles in this invention, it is recognized that in many cases the particles are substantially non-spherical. Thus, for a particle, the term “diameter” refers to the diameter of a spherical particle having equivalent volume. This can be acceptably approximated by the mean linear dimension of the particle for lines passing through the center of mass of the particle, which itself may be acceptably approximated by taking the mean of the thickness of the particle along 2 orthogonal axes of a coordinate system, with one of the axes aligned with the longest dimension of the particle. Such determination may be made, for example, using a microscope with a suitable length scale. The term “average diameter” refers to the volume medium diameter D(v,0.5), meaning that approximately 50 volume % of the particles have an equivalent spherical diameter that is smaller than the average diameter and approximately 50 volume % of the particles have an equivalent spherical diameter that is greater than the average diameter.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

What is claimed is:

1. A vitamin C-fortified processed aqueous food or beverage composition for human or animal consumption, comprising
at least one water-solubilized chemical source of vitamin C (ws-vitC); and
at least one water-insoluble microparticulate chemical source of ascorbate (i-vitC),
wherein said ws-vitC and said i-vitC are both dispersed in said composition that is free of an amount of available solvent that would dissolve said i-vitC, and wherein said i-vitC acts to reduce the rate of loss of vitamin C in said composition.

2. The composition of claim 1, wherein said ws-vitC is selected from the group consisting of ascorbic acid, sodium ascorbate, potassium ascorbate, calcium ascorbate and combinations thereof.

3. The composition of claim 1, wherein said i-vitC is selected from the group consisting of ascorbyl palmitate, ascorbyl stearate, other fatty acid esters of ascorbic acid, and combinations thereof.

4. The composition of claim 1, wherein said i-vitC comprises ascorbyl palmitate.

5. The composition of claim 1, wherein the weight average diameter of the microparticles of said i-vitC is between 1 micron and 100 microns.

6. The composition of claim 1, wherein the weight average diameter of the microparticles of said i-vitC is between 5 microns and 50 microns.

7. The composition of claim 1, wherein the weight average diameter of the microparticles of said i-vitC is between 10 microns and 25 microns.

8. The composition of claim 1, wherein said composition is free of an amount of chemically available ethyl alcohol that will dissolve the microparticles of said i-vitC.

9. The composition of claim 1, wherein said composition is free of an amount of chemically available mono- and diglycerides that will dissolve the microparticles of said i-vitC.

10. The composition of claim 1, wherein said composition is free of an amount of chemically available triglycerides that will dissolve the microparticles of said i-vitC.

11. The composition of claim 1, wherein said composition is a processed beverage selected from the group consisting of soy milks, cows milks, ready to drink fruit juices and smoothies, ready to drink vegetable juices, tea-containing beverages, coffee-containing beverages, carbonated beverages, and combinations thereof.

12. The composition of claim 1, wherein said ws-vitC and said i-vitC are combined in a ws-vitC to i-vitC weight ratio in the range of 2:1 to 100:1.

13. The composition of claim 1, wherein said ws-vitC and said i-vitC are combined in a ws-vitC to i-vitC weight ratio in the range of 5:1 to 50:1.

14. The composition of claim 1, wherein said ws-vitC and said i-vitC are combined in a ws-vitC to i-vitC weight ratio in the range of 10:1 to 25:1.

15. The composition of claim 1, wherein the amount of said ws-vitC included in a standard serving of said processed aqueous food or beverage composition is sufficient to provide at least 10% of the recommended daily intake (RDI) of vitamin C throughout the shelf life of said composition.

16. The composition of claim 1, wherein the amount of said ws-vitC included in a standard serving of said processed aqueous food or beverage composition is sufficient to provide at least 20% of the recommended daily intake (RDI) of vitamin C throughout the shelf life of said composition.

17. The composition of claim 1, wherein said processed aqueous food or beverage composition is a processed food or beverage product packaged in a container that is essentially opaque to light that would otherwise prematurely degrade said ws-vitC over the shelf life of said product.

18. A method of protecting vitamin C in a vitamin C-fortified processed aqueous food or beverage composition for human or animal consumption comprising
dispersing at least one water-soluble chemical source of vitamin C (ws-vitC) and at least one water-insoluble microparticulate chemical source of ascorbate (i-vitC) in said food or beverage composition, wherein said composition is free of an amount of available solvent that would dissolve said i-vitC, and wherein said i-vitC acts to reduce the rate of loss of vitamin C in said composition.

19. The method of claim 18, wherein said composition comprises any of the compositions of claims 2 through 17.

20. A method of assisting an individual to extend the time period of blood absorption of active vitamin C from a vitamin C-fortified processed aqueous food or beverage composition, comprising
providing said food or beverage composition to said individual for consumption, wherein said composition comprises at least one water-soluble chemical source of vitamin C (ws-vitC) and at least one water-insoluble microparticulate chemical source of ascorbate (i-vitC) dispersed in said food or beverage composition,
wherein said composition is free of an amount of available solvent that would dissolve said i-vitC, said i-vitC acts to reduce the rate of loss of vitamin C in said composition, and the weight ratio of said ws-vitC to i-vitC is in a range of 1:1 to 20:1.
